(19) United States
(12) Patent Application Publication
(10) Pub. No.: US 2009/0315653 A1
(43) Pub. Date: Dec. 24, 2009

(54) Electromagnet device and electromagnetic contactor

(75) Inventors: Kenji Suzuki, Kounosu-shi (JP); Yasuhiro Naka, Kounosu-shi (JP); Kouetsu Takaya, Kounosu-shi (JP); Toshikatsu Ohgami, Kounosu-shi (JP)

Correspondence Address: KANESAKA BERNER AND PARTNERS LLP, 1700 DIAGONAL RD, SUITE 310, ALEXANDRIA, VA, 22314-2848, US

(73) Assignee: FUJI ELECTRIC FA COMPONENTS & SYSTEMS CO., LTD, Tokyo (JP)

(21) Appl. No.: 12/385,274

(22) Filed: Apr. 3, 2009

(30) Foreign Application Priority Data
Jun. 18, 2008 (JP) 2008-158772

(51) Int. Cl. H01H 3/00; H01F 3/02

(52) U.S. Cl. 335/185; 335/297

(57) ABSTRACT

A core for an electromagnetic device includes a yoke and at least two legs extending from the yoke. The yoke and at least two legs are formed of steel plates laminated together. Each of the legs has a free end face forming a magnetic pole face, a first groove extending from the magnetic pole face and a second magnetic groove on a side face thereof. Also, the core includes a shading coil having a metal ring shape, and including a first linear section and a second linear section extending in parallel with each other. A part of the first linear section is accommodated in the first groove, and a part of the second linear section is accommodated in the second groove and locked therein. A bottom face of the second groove forms an angle with respect to a bottom face of the first groove.

### BACKGROUND OF THE INVENTION AND RELATED ART STATEMENT

The present invention relates to an electromagnet device mounted on a unit such as an electromagnetic contactor and an electromagnetic contactor provided with an electromagnet device and particularly to a device such as an electromagnet device having a core provided with a shading coil.

First, an example of an electromagnet device will be explained which has a core provided with a shading coil. A shading coil is a coil provided in a single-phase AC electromagnet for suppressing variations in an electromagnetic attractive force due to variations in alternating magnetic flux together with noises and vibrations.

FIGS. 5A and 5B are views schematically showing an example of an electromagnet device. FIG. 5A is a front view in which the electromagnet device is viewed from the direction orthogonal to both of the direction of driving a movable core and the direction of arranging legs forming each of the movable and a stationary core, and FIG. 5B is a view showing the section 5B in FIG. 5A with the section 5B being enlarged.

As shown in FIG. 5A, the electromagnet device 101 includes constituents such as a stationary core 110, a movable core 120, an operating coil 130 and a shading coil 140. Each of the stationary core 110 and the movable core 120 is an E-shaped core formed with approximately E-shaped flat rolled silicon steel sheets laminated and secured by rivets 119. The E-shaped stationary core 110 has a central leg 111 and a pair of outside legs 112 so that the central leg 111 is located between the pair of outside legs 112, thereby forming the E-shape. The E-shaped movable core 120 has a central leg 121 and a pair of outside legs 122 so that the central leg 121 is located between the pair of outside legs 122, thereby forming the E-shape. The stationary core 110 and the movable core 120 are arranged so that a magnetic pole face 112a of the outside leg 112 at each end of the stationary core 110 and a magnetic pole face 122a of the outside leg 122 at each end of the movable core 120 face each other and are supported so that the magnetic pole faces 112a and 122a are made butted against each other and made separated from each other. When the magnetic pole faces 112a of the outside leg 112 and the magnetic pole faces 122a of the outside leg 122 are made butted against each other, a gap is formed between an end face 111a of the central leg 111 and an end face 121a of the central leg 121. The reason for this configuration is to prevent the movable core 120 from returning to its original position while being kept attracted to the stationary core 110 by residual magnetic flux when a current supplied to the operating coil 130 is cut off. The operating coil 130 is wound around the central leg 111 of the stationary core 110. By turning on and off energization of the operating coil 130, the movable core 120 is butted against and separated from the stationary core 110.

The shading coil 140 is provided around the magnetic pole face 112a of each outside leg 112 of the stationary core 110. The shading coil 140 is integrally formed by stamping out an approximately square frame from a metal plate of aluminum alloy, for example.

As is shown in FIG. 5B, each of the outside legs 112 of the stationary core 110 has parallel cut grooves 115, 117 on the magnetic pole face 112a and a face 112b of a protrusion 113 on the outside of the outside leg 112, respectively. The cut grooves extend in the direction of the thickness of the stationary core 110 (in the direction orthogonal to the paper in FIG. 5B). The shading coil 140 is inserted into the cut grooves 115, 117 to be fastened to the outside leg 112 by press fitting or upsetting (squeezing).

Incidentally, in an electromagnet, the relation in an electromagnetic attractive force (F) and a magnetic pole area (S) is expressed by the following equation Eq. 1:

F=B²S (Eq. 1)

where B represents a magnetic flux density.

For securing a necessary electromagnetic attractive force with the magnetic flux density made constant, a magnetic pole area is required to have a sum of an area S1 of a magnetic pole face 112a-1 and an area S2 of a magnetic pole face 112a-2 of the outside leg 112. The magnetic pole face 112a-1 is a magnetic pole face between the central leg 111 side surface of the outside leg 112 and the central leg 111 side surface of the cut groove 115 on the inside. The magnetic pole face 112a-2 is a magnetic pole face between the cut grooves 115 and 117. Namely, a face 112b on the protrusion 113 on the outside of the outer cut groove 117 does not function as a magnetic pole face necessary for producing an electromagnetic attractive force, but is provided only for arranging and securing the shading coil 140. For providing such a structure, the protrusion 113 is formed on the outside surface of each of the outside legs 112 to protrude outward. By providing such protrusion 113, the stationary core 110 is upsized.

For obtaining a necessary electromagnetic attractive force in such an electromagnet device 101, the magnetic pole area of S1+S2 must be secured. Furthermore, from the view point of minimizing an iron loss, the cross-sectional areas in a magnetic path must be made uniform so that magnetic flux densities become equal at any cross sections in a magnetic circuit. Besides this, when there is a limitation on the outer dimensions of the electromagnet device 101 as in the case where there is a limitation on the dimension of the width of the core, for example, it becomes necessary to increase the number of laminated steel plates forming the core. In this case, the electromagnet is upsized in the direction of the thickness of the core. This increases the amount of material to be used.

Incidentally, an electromagnet provided with no face 112b on the outside of the outer cut groove 117 is also disclosed (see Japanese Unexamined Patent Application Publication No. JP-A-57-199208, for example). The electromagnet is provided with a cut groove in a line on a magnetic pole face of each outside leg and, along with this, provided with a step on the outside edge. A shading coil is inserted into the cut groove and the step to be welded to be secured to the outside leg. In this example, however, a bar-like material is wound in the cut groove and the step in a ring to form the shading coil. The electromagnet has no protrusion on the outside leg, thereby enabling to form without upsizing its core. Nevertheless, there is a problem of taking time in attaching and welding for securing the shading coil that results in poor productivity. Moreover, there is an increase in electric resistance at the section where both ends of the bar-like material for the shading coil are connected, which sometimes degrades the function as the shading coil.

Moreover, in some cases, in an electromagnet of a type provided with a cut groove and a step on a magnetic pole face like in the electromagnet disclosed in JP-A-57-199208, a shading coil stamped out in an approximately oval shape frame is inserted into the cut groove and the step, and only the coil inserted into the cut groove on the magnetic pole face is squeezed to be secured. In this case, there is a possibility of the shading coil missing by repetitive vibration caused by the driving of the electromagnet device, thereby causing a problem of making desired durability unattainable.

The invention was made in view of the foregoing problems with an object of providing an electromagnet device being excellent in productivity, capable of downsizing a core and further having well durability, and an electromagnetic contactor provided with such an electromagnet device.

Further objects and advantages of the invention will be apparent from the following description of the invention.

### SUMMARY OF THE INVENTION

The electromagnet device according to the invention includes a core formed approximately in an E-shape by laminating steel plates with a magnetic pole face formed at the top end of each of a plurality of legs of those forming the E-shape, and a shading coil integrally formed by stamping out an approximately ellipsoidal frame having a first linear section and a second linear section almost in parallel with each other from a metal plate.

Each of the legs of the core with magnetic pole faces formed at their respective top ends has a first groove formed by making the magnetic pole face dented and a second groove formed by making a side face of the leg dented and extending almost in parallel with the first groove.

Moreover, at least a part of the first linear section and at least a part of the second linear section of the shading coil are contained in the first groove and the second groove, respectively, of the core and are secured to the first groove and the second groove, respectively, by squeezing.

In the invention, one of the linear sections is inserted into the groove formed on the side face of the core, by which there is no need to provide a protrusion for supporting the shading coil which protrusion is unnecessary for providing a magnetic attractive force. Thus, with the same outer dimension of the core, the area of a magnetic pole and the cross-sectional area of a magnetic circuit can be increased, thereby contributing to generation of a magnetic attractive force. Therefore, without exerting influence on a magnetic attractive force and magnetic loss, the outer dimension of a core can be downsized. If the outer dimension of the core is the same, a magnetic attractive force can be increased. Furthermore, the coil inserted into both of the grooves is secured to the core by squeezing. This enhances the strength for securing the shading coil to the core to prevent the coil from coming off due to vibrations or impacts. Therefore, the durability of the electromagnet device can be enhanced. Furthermore, the shading coil formed by stamping is secured to the core by squeezing, thereby making it unnecessary to bond a coil to the core by winding a bar-like material in the groove of the core around the core and welding, or by winding a wire around the core many times and welding. Therefore, the shading coil can be attached to the core by a relatively simple mechanical procedure, thereby enhancing the productivity.

The squeezing is a method of bonding two objects in which a mechanical pressure is applied to one (or both) of the two objects to cause plastic deformation for contact bonding.

An electromagnetic contactor according to the invention includes the above described electromagnet device and at least one pair of contacts driven to be opened and closed by the electromagnet device.

With the electromagnetic contactor according to the invention, the core of an electromagnet device can be downsized, so that the electromagnetic contactor can be made compact and its durability can be made enhanced.

As is apparent from the foregoing explanations, according to the invention, there can be provided an electromagnet device being excellent in productivity, being capable of downsizing a core and further having well durability, and an electromagnetic contactor provided with such an electromagnet device.

### BRIEF DESCRIPTION OF THE DRAWINGS

FIG. 1A is a front view schematically showing a structure of an electromagnet device according to a first embodiment of the invention with the electromagnet device viewed from the direction orthogonal to both of the direction of driving a movable core and the direction of arranging legs forming each of the movable and a stationary core.

FIG. 1B is a cross sectional view showing the section 1B in FIG. 1A with the section 1B being enlarged.

FIG. 2 is a perspective view showing the stationary core in the electromagnet device shown in FIGS. 1A and 1B.

FIG. 3A is a cross sectional view showing a dimensional relation between a shading coil and first and second grooves formed in an outside leg of a stationary core for attaching the shading coil thereto.

FIG. 3B is a cross sectional view showing the step of pressing each of the first linear section of the shading coil inserted in the first grooves and the second linear section positioned on the side of the second groove by a squeezing tool.

FIG. 3C is a cross sectional view showing a state in which the shading coil is attached to the outside leg of the stationary core.

FIG. 4 is a front view illustrating a structure of an electromagnetic contactor according to a second embodiment of the invention.

FIG. 5 A is a front view schematically showing an example of a related electromagnet device with the electromagnet device viewed from the direction orthogonal to both of the direction of driving a movable core and the direction of arranging legs forming each of the movable and a stationary core.

FIG. 5B is a view showing the section 5B in FIG. 5A with the section 5B being enlarged.

FIG. 6 is a cross sectional view showing the section 1B in FIG. 1A according to a further embodiment.

### DETAILED DESCRIPTION OF PREFERRED EMBODIMENTS

In the following, explanation will be made in detail about embodiments of the invention with reference to the attached drawings.

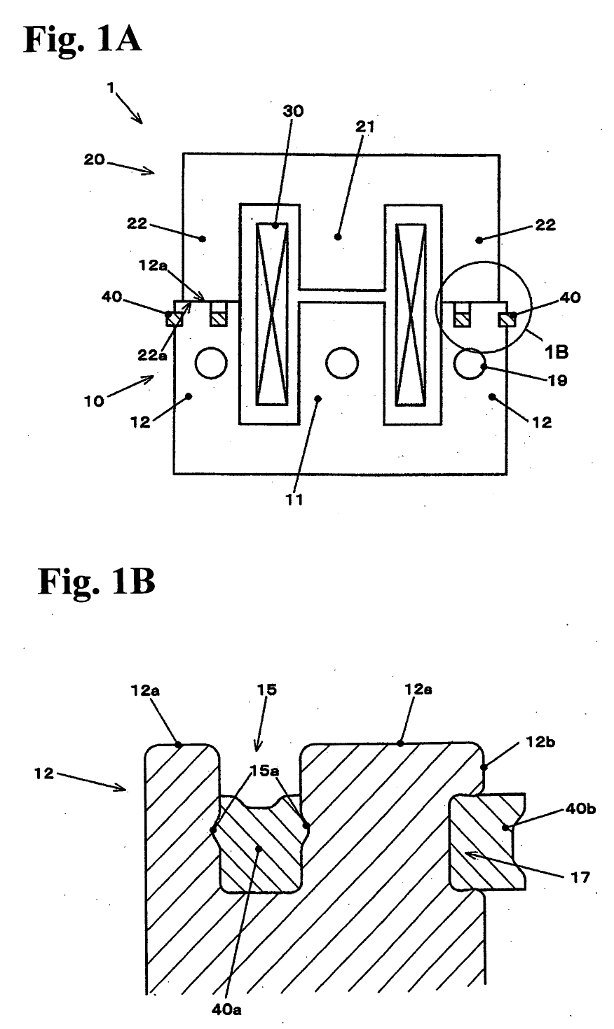

FIGS. 1A and 1B are views schematically showing a structure of an electromagnet device according to a first embodiment of the invention. FIG. 1A is a front view in which the electromagnet device is viewed from the direction orthogonal to both of the direction of driving a movable core and the direction of arranging legs forming each of the movable and a stationary core. FIG. 1B is a view showing the section 1B in FIG. 1A with the section 1B being enlarged.

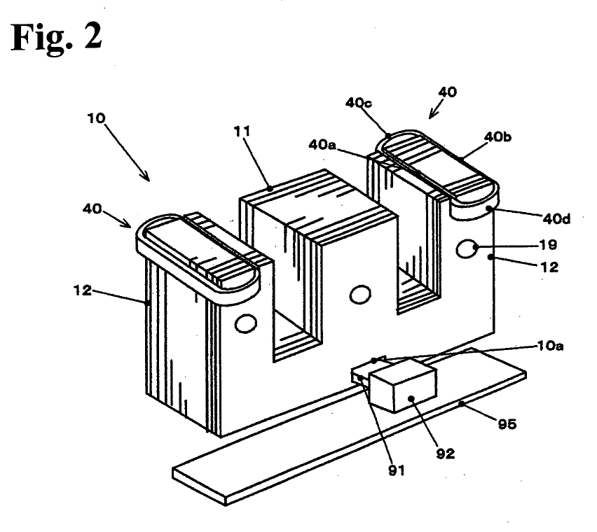

FIG. 2 is a perspective view showing the stationary core in the electromagnet device shown in FIGS. 1A and 1B.

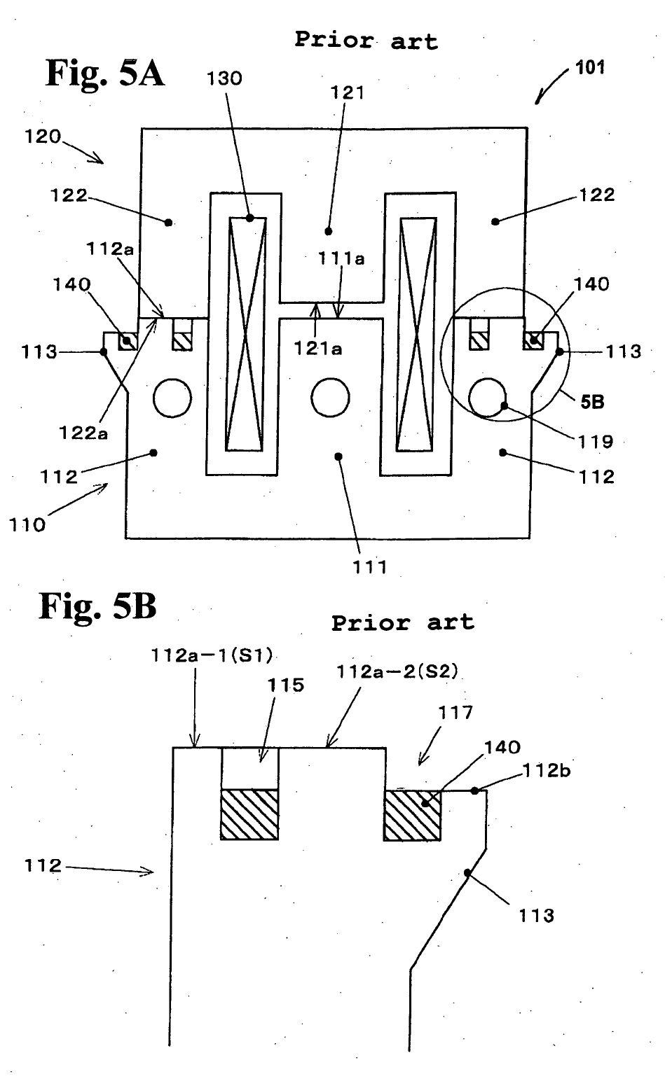

The electromagnet device 1 shown in FIGS. 1A and 1B is, like the electromagnet device shown in FIGS. 5A and 5B, formed of a stationary core 10, a movable core 20, an operating coil 30 and a shading coil 40. Each of the stationary core 10 and the movable core 20 is an E-shaped core formed with approximately E-shaped flat rolled silicon steel sheets laminated and secured by rivets 19. The E-shaped stationary core 10 has a central leg 11 and a pair of outside legs 12 arranged so that the central leg 11 is located between the pair of outside legs 12, thereby forming the E-shape. The E-shaped movable core 20 has a central leg 21 and a pair of outside legs 22 arranged so that the central leg 21 is located between the pair of outside legs 22, thereby forming the E-shape. The stationary core 10 and the movable core 20 are arranged so that a magnetic pole face 12a of the outside leg 12 at each end of the stationary core 10 and a magnetic pole face 22a of the outside leg 22 at each end of the movable core 20 face each other and are supported with relative movement between them. Therefore, it is possible that the magnetic pole faces 12a and 22a are made butted against each other and made separated from each other. The operating coil 30 is wound around the central leg 11 of the stationary core 10. By turning on and off energization of the operating coil 30, the movable core 20 is made butted against and separated from the stationary core 10.

As shown in FIG. 1B, each of the outside legs 12 has a first groove 15 on its magnetic pole face 12a at a position on the side slightly near the central leg 11. The first groove 15 is formed with the magnetic pole face 12a made dented almost perpendicularly thereto. The first groove 15 linearly extends in the direction of the thickness of the stationary core 10 (in the direction orthogonal to the paper in FIG. 1B). The cross-sectional shape of the first groove 15 viewed from its longitudinal direction is formed in approximately rectangular. Around the middle of each of the sidewalls of the first groove 15 in the direction of its depth, a groove 15a is formed into which a part of a first linear section 40a of the shading coil 40 is pressed. The shading coil 40 is subjected to plastic deformation by squeezing explained later. The groove 15a also extends in the direction of the thickness of the stationary core 10 in parallel with the first groove 15.

Each of the outside legs 12 has a second groove 17 formed on an outside face 12b at a position slightly below its upper end with the outside face 12b dented almost horizontally. Like in the first groove 1, a part of a second linear section 40b forming the shading coil 40 is pressed into the second groove 17. Here, likewise, the shading coil 40 is subjected to plastic deformation. The second groove 17 extends linearly in the direction of the thickness of the stationary core 10. The first groove 15 and the second groove 17 are almost in parallel with each other. Moreover, the height of the bottom of the first groove 15 and the height of the lower face of the second groove 17 are almost equal.

The stationary core 10 of the invention has no protrusion on the outside face 12b of each outside leg 12, unlike the protrusion 113 provided on the stationary core 110 of the electromagnet device 101 in FIGS. 5A and 5B. In the embodiment, the outside face 12b of each of the outside legs 12 is formed substantially flat except the second groove 17.

Furthermore, as shown in FIG. 2, the stationary core 10 has a through hole 10a formed so as to penetrate the stationary core 10 in its thickness direction. The through hole 10a is disposed at the end of the central leg 11 on the side opposite to the movable core 20. Into the through hole 10a, a supporting plate 91 is inserted. an elastic body 92 of an elastic material such as rubber is attached to the top end of the supporting plate 91 protruding from the through hole 10a. Moreover, on the bottom surface of a frame (not shown) in which the stationary core 10 is contained, a cushion sheet 95 is laid. By the elastic body 92 and the cushion sheet 95, the stationary core 10 is elastically supported on the frame in a so-called floating state.

The shading coil 40 is integrally formed by stamping out an approximately ellipsoidal frame from a metal plate of aluminum base alloy, for example. The shading coil 40 has, as shown in FIG. 2, the first linear section 40a and the second linear section 40b almost in parallel with each other and semicircular sections 40c and 40d facing each other.

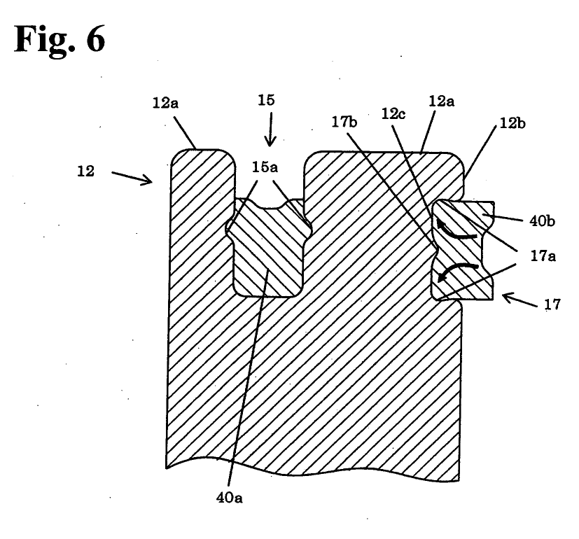

According to a further embodiment shown in FIG. 6, a protrusion 17b is formed on a bottom 12c of the second groove 17. In this embodiment, the shading coil 40 is more securely form-locked in the second groove 17 due to the protrusion 17b.

Next, an explanation will be made about an example of a method of attaching the shading coil 40 to each of the outside legs 12 of the stationary core 10.

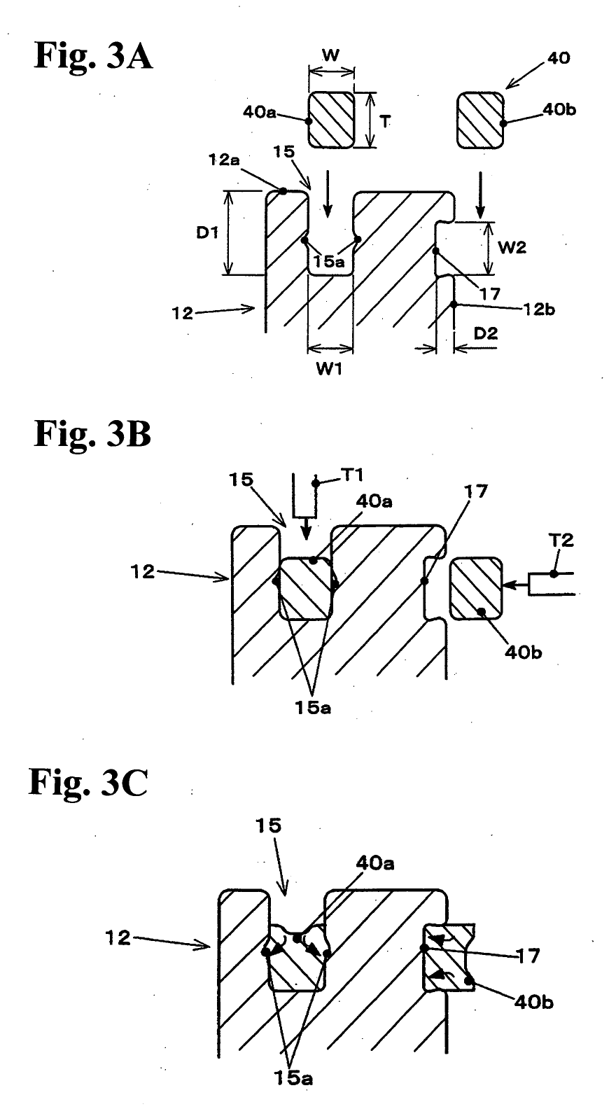

FIGS. 3A to 3C are views illustrating a method of attaching a shading coil to a magnetic pole.

Here, FIG. 3A is a cross sectional view showing a dimensional relation between a shading coil and first and second grooves formed in an outside leg of a stationary core for attaching the shading coil thereto. FIG. 3B is a cross sectional view showing the step of pressing each of the first linear section of the shading coil inserted in the first grooves and the second linear section positioned on the side of the second groove by a squeezing tool. FIG. 3C is a cross sectional view showing a state in which the shading coil has been attached to the outside leg of the stationary core.

As shown in FIG. 3A, the first groove 15 is formed so that its width W1 becomes substantially equal to the width W of each of the first linear section 40a and the second linear section 40b of the shading coil 40 except for a clearance provided for allowing the shading coil 40 to be inserted into the first groove 15. Moreover, the first groove 15 is formed so that its depth D1 becomes larger than the thickness T of each of the first linear section 40a and the second linear section 40b. In addition, the second groove 17 is formed so that its width W2 on the outside face 12b of the outside leg 12 is approximately equal to the thickness T of each of the first linear section 40a and the second linear section 40b but its width inside the outside leg 12 increases toward its bottom. Furthermore, the second groove 17 is formed so that its depth D2 is made smaller than the width W of each of the linear section 40a and the second linear section 40b.

First, as shown in FIG. 3B, the first linear section 40a of the shading coil 40 is inserted into the first groove 15 to make the second linear section 40b position on the side of the second groove 17. Next to this, the first linear section 40a is pressed from above by a squeezing tool T1 and the second linear section 40b is pressed from the side toward the second groove 17 by another squeezing tool T2.

Then, as shown in FIG. 3C, the first linear section 40a is made dented on its upper face by the squeezing tool T1, thereby being subjected to plastic deformation on its side faces so as to be pressed into the groove 15a on each of the sidewalls of the first groove 15. This can prevent the shading coil 40 from coming off. Moreover, the second linear section 40b is pressed into the second groove 17. Thus, its side face is made dented by the squeezing tool T2, and its end section inside the second groove 17 is subjected to plastic deformation upward and downward (upward and downward in the Figure) to be pressed into the inside of the second groove 17 in which the width of the second groove 17 is made widened toward the bottom. Each of the semicircular sections 40c, 40d of the shading coil 40 is deformed so as to extend outward (in the direction of the thickness of the core) from the outside leg 12 to the extent that the second linear section 40b is pressed into sideward.

As explained in the foregoing, it is unnecessary for the stationary core 10 of the electromagnet device 1 according to the invention to provide a part irrelevant to a magnetic attractive force (the face 112b in FIG. 5B) on the outside leg 12. Therefore, when the necessary magnetic attractive force of the stationary core 10 is equal to that of the related stationary core 110, the stationary core 10 can be downsized as compared to the related stationary core 110 in which the protrusion 113 is provided for securing the shading coil 140. Moreover, since the shading coil 40 inserted in both of the first groove 15 and second groove 17 is secured by squeezing, the shading coil 40 can be firmly attached to the stationary core 10 by relatively simple way. This makes the stationary core 10 excellent in productivity and durability.

Following this, an electromagnetic contactor provided with such an electromagnet will be explained.

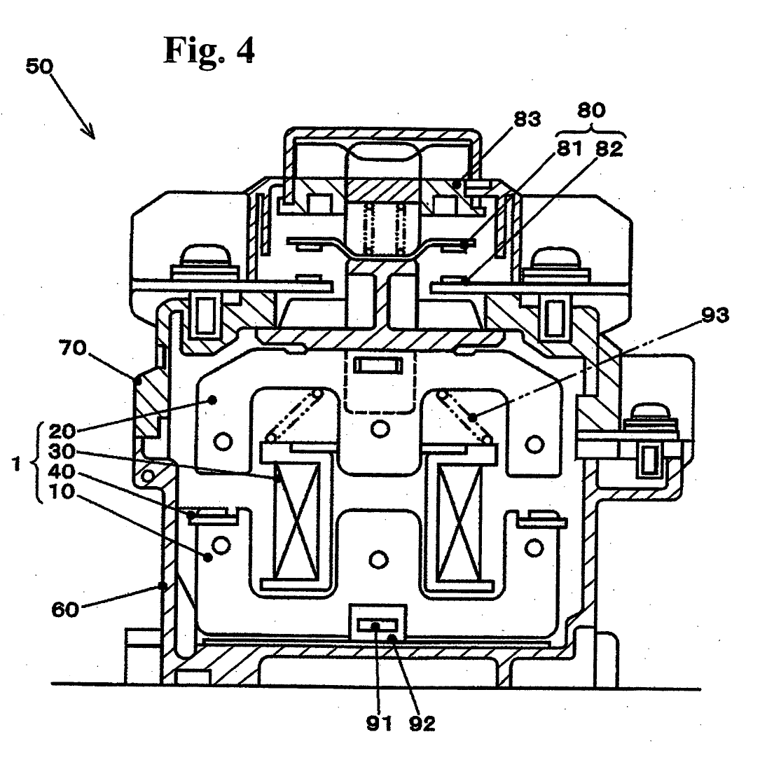

FIG. 4 is a front view illustrating the structure of an electromagnetic contactor according to a second embodiment of the invention.

The electromagnetic contactor 50, as shown in FIG. 4, has a lower frame 60 and an upper frame 70 as a lower part and an upper part, respectively, of a case that is divided into two. Inside them, components such as the electromagnet device 1 and a contactor device 80 are provided.

The electromagnet device 1 is what is explained with reference to FIGS. 1A and 1B and other drawings, and is formed of the stationary core 10, the movable core 20, the operating coil 30 and the shading coil 40. The stationary core 10 is contained in the lower frame in a floating state. The stationary core 10 has a through hole formed so as to penetrate the stationary core 10 in its thickness direction. Into the through hole, the supporting plate 91 is inserted. The elastic body 92 of an elastic material such as rubber is attached to each end of the supporting plate 91 protruding from the through hole. The supporting plate 91 is secured to the lower frame 60 by the elastic body 92 and the stationary core 10 is elastically supported on the lower frame 50 in the floating state.

The movable core 20 is contained in the upper frame 70 while facing the stationary core 10 so as to be made butted against and separated from the stationary core 10. Between the movable core 20 and the operating coil 30, a return spring 93 is provided.

The contactor device 80 has a movable contactor 81 and a stationary contactor 82 which are butted against and separated from each other, thereby switching a circuit between connection and shutoff. The movable contactor 81 is held by a movable contact holder 83. The movable contact holder 83 is supported by a connecting plate (not shown) on the back (upper face) of the movable core 20 so as to be slidable in the upper frame 70. The movable contact holder 83 is held by a contact spring (not shown). The stationary contactor 82 is secured to the upper frame 70 at a part facing the movable contactor 81.

When the operating coil 30 is energized, the stationary core 10 and the movable core 20 attract each other, thereby moving the movable core 20 to contact the stationary core 10. This makes the movable contact holder 83 supported by the movable core 20 move relative to the upper frame 70. Therefore, the movable contactor 81 is made in contact with the stationary contactor 82. With the operating coil 30 is de-energized, the movable core 20 is energized by the return spring 93 to be separated from the stationary core 10. This makes the movable contactor 81 separated from the stationary core 82.

According to the electromagnetic contactor of the second embodiment explained in the foregoing, it becomes possible to downsize its core, and enhance its productivity and its durability as explained above. Thus, the electromagnetic contactor can be downsized and productivity and durability are enhanced.

The disclosure of Japanese Patent Application No. 2008-158772 filed on Jun. 18, 2008 is incorporated as a reference.

While the invention has been explained with reference to the specific embodiments of the invention, the explanation is illustrative and the invention is limited only by the appended claims.

What is claimed is:

1. A core for an electromagnetic device, comprising:
a yoke and at least two legs extending from the yoke, said yoke and at least two legs being formed of steel plates laminated together, each of the legs having a free end face forming a magnetic pole face, a first groove extending from the magnetic pole face and a second magnetic groove on a side face thereof; and
a shading coil having a metal ring shape, and including a first linear section and a second linear section extending in parallel with each other, at least a part of the first linear section being accommodated in the first groove and at least a part of the second linear section being accommodated in the second groove so that a bottom face of the second groove forms an angle with respect to a bottom face of the first groove, the second linear section being locked in the second groove.

2. The core according to claim 1, wherein the first linear section is locked in the first groove.

3. The core according to claim 1, wherein the shading coil is an integral piece of metal having an ellipsoidal shape, the shading coil being punched out from a metal plate.

4. The core according to claim 1, wherein the core has three legs so as to form an E-shape.

5. The core according to claim 1, wherein said first groove includes a groove portion formed in at least one of side inner walls of the first groove, and an inner protrusion formed on a bottom inner face of the first groove.

6. An electromagnetic contactor comprising the core according to claim 1.

7. An electromagnetic contactor comprising the core according to claim 5.

8. The electromagnetic contactor according to claim 6, further comprising:
an electromagnetic coil wound around the core;
an armature supported to be movable between a first position and a second position, the armature being closer to the core in the first position than the second position; and
at least one pair of contacts arranged to be opened and closed in response to a movement of the armature between said first and said second positions.

9. The electromagnetic contactor according to claim 6, further comprising:
an electromagnetic coil wound around the core;
an armature supported to be movable between a first position and a second position, the armature being closer to the core in the first position than the second position; and
at least one pair of contacts arranged to be opened and closed in response to a movement of the armature between said first and said second positions.
